(19) United States
(12) Patent Application Publication
(10) Pub. No.: US 2021/0320978 A1
(43) Pub. Date: Oct. 14, 2021

(54) INFORMATION PROCESSING METHOD, APPARATUS, DEVICE, AND READABLE STORAGE MEDIUM

(71) Applicant: APOLLO INTELLIGENT CONNECTIVITY (BEIJING) TECHNOLOGY CO., LTD., Beijing (CN)

(72) Inventor: Daqing LI, Beijing (CN)

(21) Appl. No.: 17/358,348

(22) Filed: Jun. 25, 2021

(30) Foreign Application Priority Data
Dec. 10, 2020 (CN) 202011435194.X

(51) Int. Cl. H04L 29/08; H04L 9/08; H04L 29/06

(52) U.S. Cl. CPC H04L 67/12; H04L 2209/84; H04L 63/0442; H04L 9/0825

(57) ABSTRACT

The present disclosure discloses an information processing method, an apparatus, a device, and a readable storage medium, and relates to the technical fields of Internet of Vehicles, automatic driving, autonomic parking, and intelligent transportation. A specific implementation solution is that: after receiving request information, a server activates a first binding relationship between a first device identifier and a first vehicle identifier, so that the first device and the first vehicle are bound. At the same time, the server freezes a binding relationship between the first vehicle and a second device, as well as a binding relationship between a second vehicle and the first device.

CROSS-REFERENCE TO RELATED DISCLOSURE

This application claims priority to Chinese Patent Disclosure No. 202011435194.X, filed on Dec. 10, 2020, which is hereby incorporated by reference in its entirety.

### TECHNICAL FIELD

The present disclosure relates to the technical fields of Internet of Vehicles, automatic driving, autonomic parking, and intelligent transportation, in particular to an information processing method, an apparatus, a device, and a readable storage medium.

### BACKGROUND

With rapid development of Internet of Vehicles technology, more and more vehicles are equipped with an on-board terminal, through which a service can be pushed to a specific vehicle.

In order to push the service to the specific vehicle accurately, it is necessary to bind the vehicle and the on-board terminal. In a common binding method, a unique device ID is written in a storage area of the on-board terminal, and similarly, a unique vehicle identification number (VIN) is also written in a storage area of the vehicle. When the on-board terminal is assembled on the vehicle, a corresponding relationship between the device ID and the VIN is sent to a server through a computer of a production line or a 4S repair shop.

### SUMMARY

The present disclosure provides an information processing method, an apparatus, a device, and a readable storage medium, which binds a vehicle and an on-board terminal in an automatic way, and has high efficiency and is not error-prone.

In a first aspect, an embodiment of the present disclosure provides an information processing method, including:

receiving request information from a first device, where the request information carries a first device identifier for identifying the first device and a first vehicle identifier for identifying a first vehicle;

activating a first binding relationship between the first device identifier and the first vehicle identifier; and

freezing a second binding relationship and a third binding relationship, where the second binding relationship is a binding relationship between the first device identifier and a second vehicle identifier for identifying a second vehicle, and the third binding relationship is a binding relationship between a second device identifier for identifying a second device and the first vehicle identifier.

In a second aspect, an embodiment of the present disclosure provides an information processing method, including:

obtaining a first device identifier for identifying a first device and a first vehicle identifier for identifying a first vehicle; and

sending request information to a server, where the request information carries the first device identifier and the first vehicle identifier.

In a third aspect, an embodiment of the present disclosure provides an information processing apparatus, including:

a transceiving module, configured to receive request information from a first device, where the request information carries a first device identifier for identifying the first device and a first vehicle identifier for identifying a first vehicle;

an activating module, configured to activate a first binding relationship between the first device identifier and the first vehicle identifier; and

a processing module, configured to freeze a second binding relationship and a third binding relationship, where the second binding relationship is a binding relationship between the first device identifier and a second vehicle identifier for identifying a second vehicle, and the third binding relationship is a binding relationship between a second device identifier for identifying a second device and the first vehicle identifier.

In a fourth aspect, an embodiment of the present disclosure provides an information processing apparatus, including:

a processing module, configured to obtain a first device identifier for identifying a first device and a first vehicle identifier for identifying a first vehicle; and

a transceiving module, configured to send request information to a server, where the request information carries the first device identifier and the first vehicle identifier.

In a fifth aspect, an embodiment of the present disclosure provides an electronic device, including:

at least one processor; and

a memory communicatively connected to the at least one processor; where,

the memory stores an instruction executable by the at least one processor, and the instruction is executed by the at least one processor to enable the at least one processor to execute the method according to the first aspect or the method according to any possible implementation of the first aspect.

In a sixth aspect, an embodiment of the present disclosure provides an electronic device, including:

at least one processor; and

a memory communicatively connected to the at least one processor; where,

the memory stores an instruction executable by the at least one processor, and the instruction is executed by the at least one processor to enable the at least one processor to execute the method according to the second aspect or the method according to any possible implementation of the second aspect.

In a seventh aspect, an embodiment of the present disclosure provides a computer program product including an instruction, and when the instruction is run on an electronic device, a computer of the electronic device is enabled to execute the method according to the first aspect or the method according to various possible implementations of the first aspect.

In an eighth aspect, an embodiment of the present disclosure provides a computer program product including an instruction, and when the instruction is run on an electronic device, a computer of the electronic device is enabled to execute the method according to the second aspect or the method according to various possible implementations of the second aspect.

In a ninth aspect, an embodiment of the present disclosure provides a non-transitory computer readable storage medium storing a computer instruction, where the computer instruction is used to enable an electronic device to execute the method according to the first aspect or the method according to various possible implementations of the first aspect.

In a tenth aspect, an embodiment of the present disclosure provides a non-transitory computer readable storage medium storing a computer instruction, where the computer instruction is used to enable an electronic device to execute the method according to the second aspect or the method according to various possible implementations of the second aspect.

It should be understood that what is described in the present section is not intended to identify key or important features of embodiments of the present disclosure, nor is it intended to limit scope of the present disclosure. Other features of the present disclosure will become easily understood from following descriptions.

### BRIEF DESCRIPTION OF DRAWINGS

The drawings are for better understanding of the present solution and do not constitute a limitation of the present disclosure. Where:

FIG. 1 is a schematic diagram of a network architecture to which an information processing method provided by an embodiment of the present disclosure is applicable;

FIG. 2 is a flowchart of an information processing method provided by an embodiment of the present disclosure;

FIG. 3A is a schematic diagram of a process of generating a first binding identifier in an information processing method provided by an embodiment of the present disclosure;

FIG. 3B is a schematic diagram of a process of processing a first character in an information processing method provided by an embodiment of the present disclosure;

FIG. 4 is another flowchart of an information processing method provided by an embodiment of the present disclosure;

FIG. 5 is yet another flowchart of an information processing method provided by an embodiment of the present disclosure;

FIG. 6 is a structural schematic diagram of an information processing apparatus provided by an embodiment of the present disclosure;

FIG. 7 is another structural diagram of an information processing apparatus provided by an embodiment of the present disclosure; and

FIG. 8 is a block diagram of an electronic device for implementing an information processing method of an embodiment in the present disclosure.

### DESCRIPTION OF EMBODIMENTS

Exemplary embodiments of the present disclosure are described below in conjunction with the drawings, where various details of the embodiments of the present disclosure are included to facilitate understanding, which should be considered as merely exemplary. Therefore, it should be recognized by persons of ordinary skilled in the art that various changes and modifications can be made to the embodiments described herein without departing from scope and spirit of the present disclosure. Similarly, for the sake of clarity and conciseness, descriptions of well-known functions and structures are omitted in the following description.

At present, many vehicles are equipped with an on-board terminal, and the vehicles are networked through the on-board terminal to implement intelligent navigation, vehicle condition inquiry, and other services. In order to ensure that a server can accurately push a service to a specific vehicle, the vehicle and the on-board terminal are required to be bound.

Since an on-board terminal is assigned with a unique device identification (Device ID) before a delivery, the device identification is also called a device number; Similarly, the vehicle is assigned with a unique vehicle identification number (VIN) before a delivery, and the VIN is also called a vehicle frame number. Therefore, in a common binding method, when an on-board terminal device is assembled to a vehicle in a factory, a binding relationship between a VIN and a device ID is sent to a server by a computer of the factory, thereby realizing a binding between the vehicle and the on-board terminal device.

The above-mentioned way of binding the vehicle and the on-board terminal requires an extra operation in the production line in a manual way, which is inefficient and prone to errors.

After a delivery of the vehicle, if the on-board terminal device on the vehicle is replaced, the VIN of the vehicle and a device ID of a new on-board terminal device will be sent to the server through a computer of a 4S shop, so that the server can establish a binding relationship between the VIN and the new device ID.

In the binding method, the VIN and the device ID are uploaded by an additional computer during production or repair and replacement, so that the binding relationship between the VIN and the device ID is established, which is inefficient and prone to errors. Moreover, there is no guarantee that one vehicle can only be bound to one on-board terminal while one on-board terminal can only be bound to one vehicle.

Embodiments of the present disclosure relates to the technical fields of Internet of Vehicles, automatic driving, autonomic parking, and intelligent transportation, aiming at, by binding a vehicle and a device in an automatic way, improving binding efficiency and reducing an error rate, and achieving that one vehicle can only be bound to one on-board terminal at any time while one on-board terminal can only be bound to one vehicle.

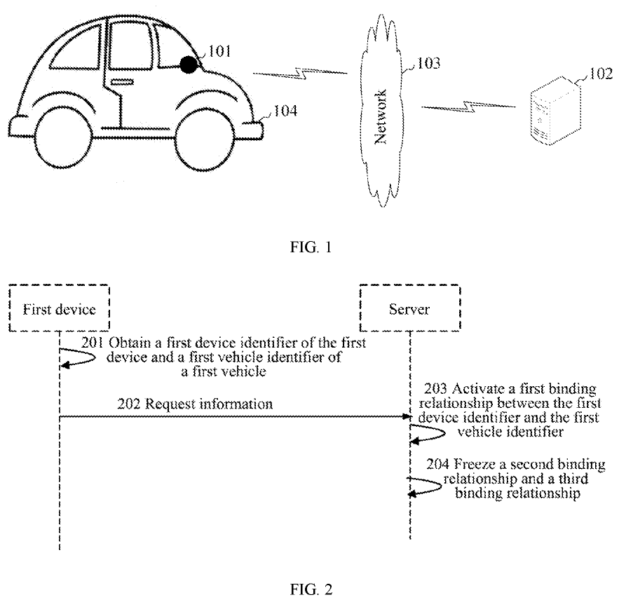

FIG. 1 is a schematic diagram of a network architecture to which an information processing method provided by an embodiment of the present disclosure is applicable. Referring to FIG. 1, the network architecture includes an on-board terminal 101, a server 102, a network 103, and a vehicle 104. The on-board terminal 101 is provided in the vehicle 104, and the on-board terminal 101 and the vehicle 104 are connected by a bus, such as a controller area network (CAN) bus. The on-board terminal 101 and the server 102 establish a network connection through the network 103. The network 103 includes a wifi network, a data network, etc.

A user interacts with the server 102 through the network 103 using the on-board terminal 101 to receive or send a message. The on-board terminal 101 is installed with various communication client disclosures, such as a video playing disclosure, a navigation disclosure, a search disclosure, an instant messaging tool, and a mailbox client. The on-board terminal 101 is also called a vehicle machine, an intelligent on-board device, an intelligent on-board terminal, a vehicle dispatching and monitoring terminal, an on-board wireless terminal, etc.

The server 102 is a server capable of providing various services, such as a billing service and a message pushing service. The server 102 is used to set a binding relationship between the vehicle and the on-board terminal, and push a service to a specific vehicle according to the binding relationship between the vehicle and the on-board terminal.

The server 102 may be hardware or software. When the server 102 is hardware, the server 102 is a distributed server cluster composed of a single server or a plurality of servers. When the server 102 is software, the server 102 may be a plurality of software modules or a single software module, etc., which is not limited by the embodiment of present disclosure.

It should be understood that the number of the on-board terminal 101, the server 102, and the network 103 in FIG. 1 is only illustrative. In an actual implementation, any number of the on-board terminal 101, the server 102, and the network 103 are deployed according to actual demands

In the below, based on the network architecture shown in FIG. 1, an information processing method described in the embodiment of the present disclosure is described in detail. Exemplarily, please make reference to FIG. 2.

FIG. 2 is a flowchart of an information processing method provided by an embodiment of the present disclosure. The present embodiment is explained from a perspective of an interaction between a server and an on-board terminal, and the present embodiment includes:

201, a first device obtains a first device identifier of the first device and a first vehicle identifier of a first vehicle.

In the embodiment of the present disclosure, the first device is an on-board terminal, etc. Taking the first device being an on-board terminal as an example, each on-board terminal is assigned with a unique on-board terminal identifier before a delivery, the unique on-board terminal identifier is, for example, a device ID, and each on-board terminal has its own unique on-board terminal identifier. Before the delivery, a device identifier of the on-board terminal is written into a safe area on a memory of the on-board terminal. Similarly, each vehicle is assigned with a unique vehicle identifier before a delivery, the unique vehicle identifier is, for example, a VIN, and each vehicle has its own unique vehicle identifier. Before the delivery, the vehicle identifier is written into a safe area on a memory of the vehicle.

The first device is installed on the first vehicle. When the first device is enabled, the first device reads the first device identifier from a local safe area; and at the same time, the first vehicle identifier stored in a safety area of the vehicle is obtained through a CAN bus.

202, the first device sends request information to the server.

Accordingly, the server receives the request information from the first device.

The request information carries the first device identifier for identifying the first device and the first vehicle identifier for identifying the first vehicle.

203, the server activates a first binding relationship between the first device identifier and the first vehicle identifier.

After receiving the first device identifier and the first vehicle identifier sent by the first device, the server considers that the first device is installed on the first vehicle, thus the server activates the first binding relationship between the first device identifier and the first vehicle identifier. In a subsequent service pushing project, the server determines the first device bound to the first vehicle according to the first binding relationship, and pushes a service to the first device, thereby pushing the service to a specific vehicle.

204, the server freezes a second binding relationship and a third binding relationship.

The second binding relationship is a binding relationship between the first device identifier and a second vehicle identifier for identifying a second vehicle, and the third binding relationship is a binding relationship between a second device identifier for identifying a second device and the first vehicle identifier.

Exemplarily, when receiving the first device identifier and the first vehicle identifier, the server considers that the first device is currently installed on the first vehicle. In order to ensure that one vehicle can only be bound to one on-board terminal and one on-board terminal can only be bound to one vehicle at any time, the server freezes the second binding relationship and the third binding relationship in an old binding relationship, that is, unbinding a binding relationship between the first vehicle and the second device, as wells as a binding relationship between the second vehicle and the first device.

According to the information processing method provided by the embodiment of the present disclosure, every time the first device is enabled, the request information carrying the first device identifier for identifying the first device and the first vehicle identifier for identifying the first vehicle is sent to the server. After receiving the request information, the server activates the first binding relationship between the first device identifier and the first vehicle identifier, so that the first device and the first vehicle are bound. At the same time, the server freezes the binding relationship between the first vehicle and the second device, as well as the binding relationship between the second vehicle and the first device. By using this method, a vehicle and an on-board terminal are bound automatically, thereby improving binding efficiency and reducing an error rate, and at the same time, achieving that one vehicle can only be bound to one on-board terminal at any time while one on-board terminal can only be bound to one vehicle.

In the embodiment, when the server activates the first binding relationship between the first device identifier and the first vehicle identifier, the server generates a first binding identifier according to the first device identifier and the first vehicle identifier. A binding relationship table is stored in a remote or local database of the server, the binding relationship table stores a corresponding relationship among a device identifier, a vehicle identifier, and a binding identifier. Different corresponding relationships contain different binding identifiers, and at least one of the device identifier and the vehicle identifier is different. The binding identifier in the binding relationship table is, for example, a unique identifier generated by the server for the device identifier and the vehicle identifier using an algorithm, and the binding identifier is, for example, a universally unique identifier (UUID). Taking the first device being an on-board terminal and the device ID being an on-board terminal identifier as an example, each binding identifier in the relationship table satisfies the following conditions:

1. For a same group of vehicle identifiers and on-board terminal identifiers, a binding identifier generated each time by the server for this group of vehicle identifiers and on-board terminal identifiers is the same. That is to say, as long as the on-board terminal identifier and the vehicle identifier are consistent, a same binding identifier will be generated in each operation;

2. As long as either of the on-board terminal identifier or the vehicle identifier changes, the server generates a different binding identifier;

3. At any time, each binding identifier corresponds to a unique identifier bit, and the unique identifier bit is used to indicate a state of a binding relationship corresponding to the binding identifier, such as an activated state or a frozen state. When a binding identifier is in an activated state, it means that a binding relationship corresponding to the binding identifier is available, and the server can determine a vehicle where the on-board terminal is located according to the binding relationship, and push a service. When a binding identifier is in a frozen state, it means that a binding relationship corresponding to the binding identifier is unavailable.

TABLE 1

| | On-board | | |
|---|---|---|---|
| Vehicle | terminal | Binding | Identifier |
| identifier | identifier | identifier | bit |
| VIN 1 | Device ID a | UUID A | 1 |
| VIN 2 | Device ID b | UUID B | 0 |
| VIN 1 | Device ID b | UUID C | 0 |

For example, in Table 1, UUID A and UUID B are different UUIDs, and UUID A and UUID B correspond to a same vehicle identifier, but their on-board terminal identifiers are different; and UUID A and UUID C are different, and UUID A and UUID C correspond to a same on-board terminal identifier, but their vehicle identifier are different. An identifier bit of UUID A is 1, which means that UUID A is in an activated state; identifier bits of UUID B and UUID C are 0, which means that the two UUIDs are in a frozen state.

After the server generates the first binding identifier, if the first binding identifier does not exist in the relationship table, the first device identifier, the first vehicle identifier, and the first binding identifier are written into the binding relationship table, that is, the first binding relationship, the first binding identifier, and a corresponding relationship between the first binding relationship and the first binding identifier are stored in the binding relationship table.

When the first binding identifier exists in the binding relationship table and the first binding identifier is in an activated state, it means that the first device and the first vehicle have been bound and the binding relationship is valid. When the first binding identifier exists in the binding relationship table and the first binding identifier is in a frozen state, it means that the first device and the first vehicle were once bound, and subsequently the first device is transferred to another vehicle, or the first vehicle is bound to the second device. After that, the first device is re-bound to the first vehicle. At this time, the server sets the first binding identifier to be in an activated state and reactivates the binding relationship between the first vehicle and the first device. In addition, in order to prevent replacement errors, the server sends prompt information to the first device to prompt the user that the first device has been transferred to other vehicles repeatedly and whether to continue binding the first device and the first vehicle.

With this solution, a purpose that the server can quickly bind the first vehicle and the first device is realized.

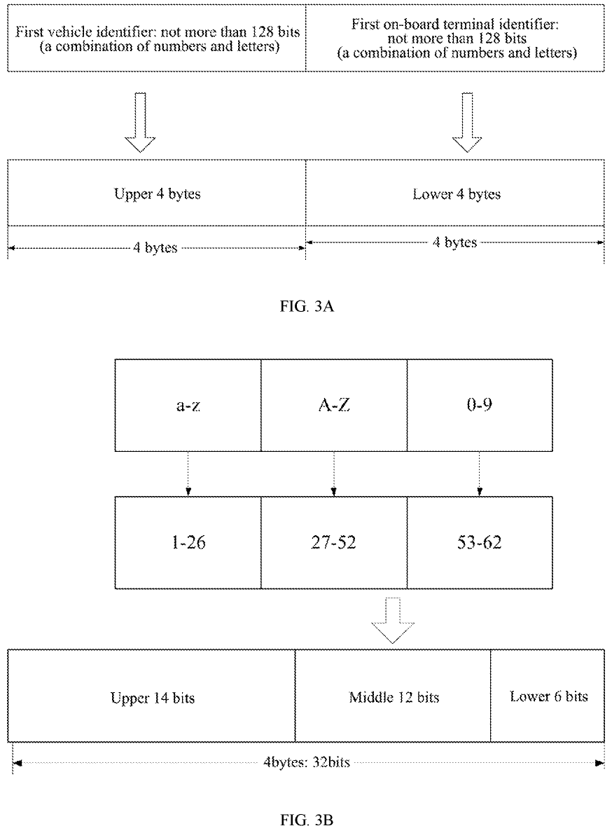

In the embodiment, when the server generates the first binding identifier, in one way, since the first device identifier and the first vehicle identifier are unique respectively, the server combines the first device identifier and the first vehicle identifier into a character string, the character string is also unique, and the server takes the character string as the first binding identifier. In another way, the server determines a first binary number and a second binary number of a first character in the first vehicle identifier, where the first binary number is used to represent a position of the first character in the first vehicle identifier, the second binary number is used to represent a value of the first character, and the first character is any character in the first vehicle identifier; and determines first target bytes according to the first binary number and the second binary number of each first character in the first vehicle identifier. At the same time, the server determines a third binary number and a fourth binary number of a second character in the first device identifier, where the third binary number is used to represent a position of the second character in the first device identifier, and the fourth binary number is used to represent a value of the second character; and determines second target bytes according to the third binary number and the fourth binary number of each second character in the first device identifier. Then, the server generates the first binding identifier according to the first target bytes and the second target bytes. Exemplarily, please make reference to FIG. 3A.

FIG. 3A is a schematic diagram of a process of generating a first binding identifier in an information processing method provided by an embodiment of the present disclosure. Referring to FIG. 3A, both the first device identifier and the first vehicle identifier are character strings not more than 128, and the character strings are combinations of numbers and letters. A number is, for example, 0 to 9, and a letter is, for example, a to z, A to Z, etc. Where, a to z may be represented by numbers 1 to 26, A to Z may be represented by numbers 27 to 52, and 0 to 9 may be represented by numbers 53 to 62.

The first binding identifier generated by the server is 8 bytes, and upper 4 bytes of the 8 bytes are generated according to the first vehicle identifier, the upper 4 bytes are also called first target bytes. Lower 4 bytes are generated according to the first device identifier, and the lower 4 bytes are also called second target bytes. In the below, how the server generates the upper 4 bytes will be explained in detail. The lower 4 bytes are generated in a similar way to those of the upper 4 bytes.

FIG. 3B is a schematic diagram of a process of processing a first character in an information processing method provided by an embodiment of the present disclosure.

Referring to FIG. 3B, the upper 4 bytes include 32 bits. Lower 6 bits of the 32 bits are determined according to a value of the first character, and a to z, A to Z, and 0 to 9 may be represented by 0 to 63, that is, a decimal value of the 6 bits ranges from 0 to 63. First 14 bits of the 32 bits are determined according to a position of the first character in the first vehicle identifier, and a represented range thereof is 0 to 16383, where upper 7 bits are reserved for carry and lower 7 bits are used to represent the position of the first character, and a range thereof is 0 to 128. According to a decimal calculation, 0 to 63 represents a first bit; 64 to 127 represents a second position; and (n-1)×64 to (n×64-1) represents a n-th bit, where 0≤n≤128 and is an integer. The remaining middle 12 bits are all 0. The first character is any character in the first vehicle identifier.

It is assumed that the first vehicle identifier is a 17-byte character string, which is ab0123456789abcde from right to left, a character on a first bit is e, a character on a second bit is d, and a character on a third bit is c . . . . Since a to z are represented by numbers in 1 to 26, the character e on the first bit has a value of 5; the character d on the second bit has a value of 4; the character c on the third bit has a value of 3; the character b on the fourth bit has a value of 2; and the character a on the fifth bit has a value of 1. Then following relationships can be obtained:

1) e=5+0×64, upper 14 bits are 0000000000000, and lower 6 bits are 000101;

2) d=4+1×64, upper 14 bits are 0000000000001, and lower 6 bits are 000100;

3) c=3+2×64, upper 14 bits are 000000000010, and lower 6 bits are 000011;

4) b=2+3×64, upper 14 bits are 000000000011, and lower 6 bits are 000010;

5) a=1+5×64, upper 14 bits are 000000000110, and lower 6 bits are 000001.

In this way, upper 14 bits and lower 6 bits of each first character in the 17-byte first vehicle identifier can be obtained. The upper 14 bits are also called the first binary number and the lower 6 bits are also called the second binary number.

After that, the server sums 17 second binary numbers, and once a sum is greater than 111111, then a carry is performed, that is, middle 12 bits has been changed; similarly, the server sums 17 first binary numbers. Then, the server can obtain the first target bytes of 32 bits, that is, upper 4 bytes.

The server processes the first device identifier in the same way to obtain the second target bytes, that is, the lower 4 bytes. After that, the server obtains an 8-byte first binding identifier according to the upper 4 bytes and the lower 4 bytes, and converts the 8-byte first binding identifier to decimal.

After obtaining a decimal first binding identifier, the server stores the first vehicle identifier, the first device identifier, and the decimal first binding identifier in the binding relationship table. When a service is pushed later, the service to be pushed carries the decimal first binding identifier, and the server directly determines the first device and the first vehicle from the binding relationship table according to the first binding identifier, without traversing all binding identifiers, which is fast in searching and occupies less space.

It should be noted that although the upper 4 bytes are obtained according to the first vehicle identifier and the lower 4 bytes are obtained according to the first device identifier, it is not limited by the embodiment of the present disclosure. In other feasible ways, the upper 4 bytes may be obtained according to the first device identifier, and the lower 4 bytes may be obtained according to the first vehicle identifier.

In the embodiment, after the server generates the first binding identifier, if the first binding identifier does not exist in the binding relationship table, the server searches the binding relationship table according to the first device identifier and determines whether the second binding relationship exists in the binding relationship table. If the second binding relationship exists in the binding relationship table, it is determined that the first device has been bound to the second vehicle, which indicates that the first device is installed on the first vehicle after being detached from the second vehicle; and if the second binding relationship does not exist in the binding relationship table, it means that the first device is a brand-new on-board terminal and has never been bound to a certain vehicle.

With this solution, a purpose of tracking which vehicles the first device has been used on is achieved.

In the embodiment, after the server generates the first binding identifier, if the first binding identifier does not exist in the binding relationship table, the server searches the binding relationship table according to the first vehicle identifier and determines whether the third binding relationship exists in the binding relationship table. If the third binding relationship exists in the binding relationship table, it is determined that the first vehicle has been bound to the second device, which means that the first vehicle has used the second device before, and then the second device is detached and the first device is installed; if the third binding relationship does not exist in the binding relationship table, it means that the first vehicle has never been bound to any on-board terminal.

With this solution, a purpose of tracking which on-board terminals have been used by vehicles is achieved.

In the embodiment, the server generates a key pair in advance, where the key pair includes a public key and a private key. Then, the server sends the public key to the first device.

Exemplarily, before the delivery of the first device, the server uses an asymmetric encryption algorithm to generate the key pair and sends the public key in the key pair to the first device. After receiving the public key, the first device uses the public key to encrypt data to be encrypted and send it to the server, thus improving reliability of a previous communication between the server and the first device.

In the embodiment, after receiving the public key, the first device uses the public key to encrypt the first device identifier and the first vehicle identifier to obtain encrypted data. Then, the encrypted data is carried in the request information and sent to the server. After receiving the encrypted data, the server decrypts the encrypted data using a local private key to obtain the first device identifier and the first vehicle identifier.

Exemplarily, in order to prevent the first device identifier and the first vehicle identifier in the request information from being tampered or intercepted, the first device encrypts the first device identifier and the first vehicle identifier using the public key to obtain the encrypted data. Then, the encrypted data is sent to the server.

With this solution, the reliability of the previous communication between the server and the first device is improved.

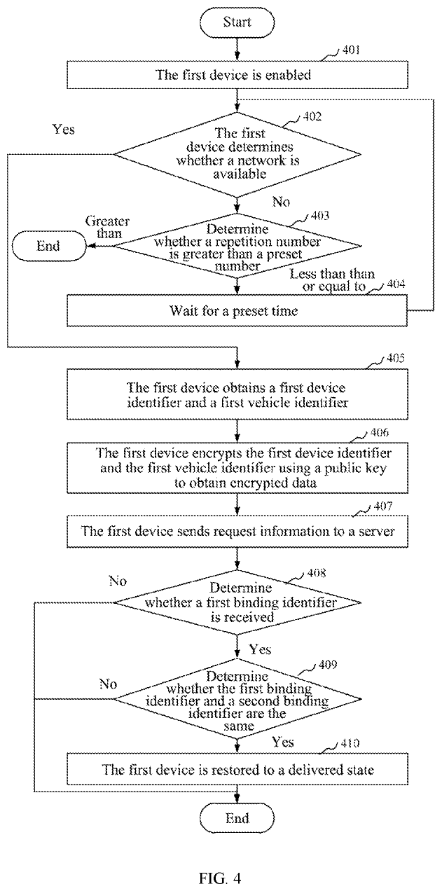

FIG. 4 is another flowchart of an information processing method provided by an embodiment of the present disclosure. The embodiment is explained from a perspective of a first device, and the present embodiment includes:

401, the first device is enabled.

The first device and a first vehicle may be enabled at the same time or at different time. For example, when a user wants to pick up a vehicle from an underground garage, the vehicle is powered on and the first device and the first vehicle are enabled at the same time; for another example, when the user rests on a roadside and wants to use the first device for entertainment, the first device is enabled.

402, the first device determines whether a network is available. If the network is not available, step 403 is executed; and if the network is available, step 405 is executed.

403, determine whether a repetition number is greater than a preset number. If the repetition number is less than or equal to the preset number, step 404 is executed; and if the repetition number is larger than the preset number, the method ends.

Exemplarily, the repetition number is, for example, 5, which is not limited by the embodiment of the present disclosure.

404, wait for a preset time, and then execute step 402.

Exemplarily, the preset time is, for example, 60 seconds, which is not limited by the embodiment of the present disclosure.

405, the first device obtains a first device identifier and a first vehicle identifier.

406, the first device encrypts the first device identifier and the first vehicle identifier using a public key to obtain encrypted data.

407, the first device sends request information to a server.

The request information carries the encrypted data.

408, the first device determines whether a first binding identifier is received. If the first device receives the first binding identifier, step 409 is executed; and if the first device does not receive the first binding identifier, the method ends.

409, the first device determines whether the first binding identifier and a second binding identifier are the same. If the first binding identifier and the second binding identifier are different, step 410 is executed; and if the first binding identifier and the second binding identifier are the same, the method ends.

410, the first device is restored to a delivered state.

Exemplarily, if the first binding identifier and the second binding identifier are different, it means that the first device has been used on other vehicles. Historical data on the first device are generated by other users operating the first device, such as navigation data and Internet access data, which is not related to the user of the first vehicle. Therefore, the first device destroys the historical data, thereby restoring the first device to a delivered value.

With this solution, by automatically destroying the historical data for restoring to a delivered value, a purpose of releasing storage space, memory, and other resources of the first device is achieved.

In the embodiment, before executing step 205, the first device also determines whether the second binding identifier is saved locally. If the second binding identifier is not saved locally, it means that the first device is a brand-new on-board terminal and has never been used in other vehicles. At this time, after receiving the first binding identifier, the first device directly stores the first binding identifier locally. If the second binding identifier is saved locally, it means that the first device is not a brand-new on-board terminal, and is once bound to a certain vehicle while the binding relationship is frozen, or, is bound to a certain vehicle while the binding relationship is in an activated state.

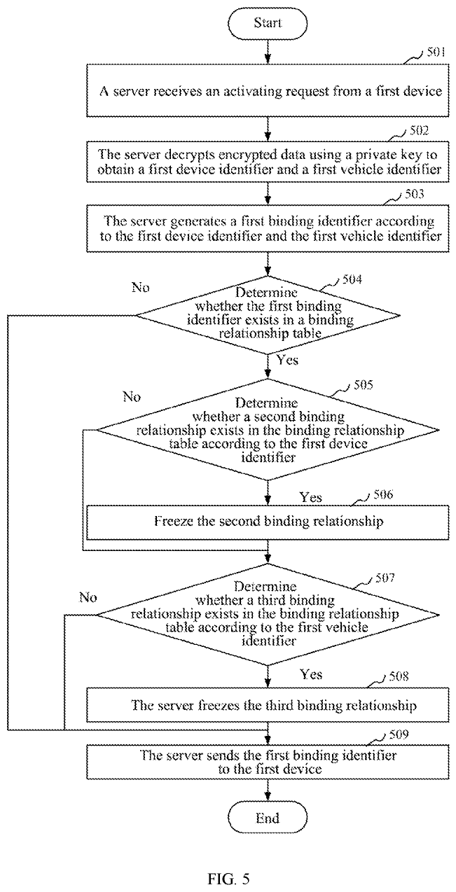

FIG. 5 is yet another flowchart of an information processing method provided by an embodiment of the present disclosure. The embodiment is explained from a perspective of a first vehicle, and the present embodiment includes:

501, a server receives request information from a first device.

The request information carries encrypted data, and the encrypted data is obtained by encrypting a first device identifier and a first vehicle identifier by the first device using a public key.

502, the server decrypts the encrypted data using a private key to obtain the first device identifier and the first vehicle identifier.

503, the server generates a first binding identifier according to the first device identifier and the first vehicle identifier.

504, the server determines whether the first binding identifier exists in a binding relationship table. If the first binding identifier does not exist in the binding relationship table, step 505 is executed; and if the first binding identifier exists in the binding relationship table, step 509 is executed.

505, the server determines whether a second binding relationship exists in the binding relationship table according to the first device identifier. If the second binding relationship exists in the binding relationship table, step 506 is executed; and if the second binding relationship does not exist in the binding relationship table, step 507 is executed.

The second binding relationship is a binding relationship between the first device identifier and a second vehicle identifier.

506, the server freezes the second binding relationship.

Exemplarily, the server marks a binding identifier of the first device previous as being in an invalid state, that is, in a frozen state.

507, the server determines whether a third binding relationship exists in the binding relationship table according to the first vehicle identifier. If the third binding relationship exists in the binding relationship table, step 508 is executed; and if the third binding relationship does not exist in the binding relationship table, step 509 is executed.

508, the server freezes the third binding relationship.

Exemplarily, the server marks a binding identifier of the first vehicle previous as being in an invalid state, that is, in a frozen state.

509, the server sends the first binding identifier to the first device.

Exemplarily, the server determines whether the first binding identifier exists in the binding relationship table, and if so, set the first binding identifier to be in an activated state and send the first binding identifier to the first device. If the first binding identifier does not exist in the binding relationship table, a corresponding relationship among the first device identifier, the first vehicle identifier, and the first binding identifier is added to the binding relationship table, and the first binding identifier is set to be in an activated state.

According to technologies of the present disclosure, a vehicle and an on-board terminal are bound automatically, thereby improving binding efficiency and reducing an error rate, and at the same time, achieving that one vehicle can only be bound to one on-board terminal at any time while one on-board terminal can only be bound to one vehicle.

The above describes a specific implementation of the information processing method mentioned in the embodiment of the present disclosure. The following are apparatus embodiments of the present disclosure, which may be used to execute the method embodiments of the present disclosure. For details not disclosed in the apparatus embodiments of the present disclosure, please make reference to the method embodiments of the disclosure.

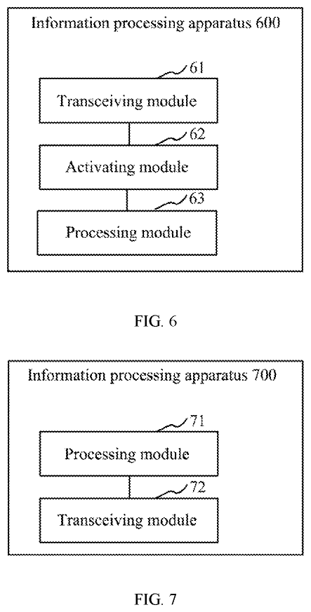

FIG. 6 is a structural schematic diagram of an information processing apparatus provided by an embodiment of the present disclosure. The apparatus may be integrated in an electronic device or implemented by an electronic device such as a server. As shown in FIG. 6, in the present embodiment, the information processing apparatus 600 may include:

a transceiving module 61, configured to receive request information from a first device, where the request information carries a first device identifier for identifying the first device and a first vehicle identifier for identifying a first vehicle;

an activating module 62, configured to activate a first binding relationship between the first device identifier and the first vehicle identifier; and

a processing module 63, configured to freeze a second binding relationship and a third binding relationship, where the second binding relationship is a binding relationship between the first device identifier and a second vehicle identifier for identifying a second vehicle, and the third binding relationship is a binding relationship between a second device identifier for identifying a second device and the first vehicle identifier.

In a feasible design, the activating module 62 is configured to generate a first binding identifier according to the first device identifier and the first vehicle identifier; when the first binding identifier does not exist in a binding relationship table, add the first binding relationship, the first binding identifier, and a corresponding relationship between the first binding relationship and the first binding identifier to the binding relationship table, where the binding relationship table is used to store a corresponding relationship among a device identifier, a vehicle identifier, and a binding identifier, different corresponding relationships contain different binding identifiers, and at least one of the device identifier and the vehicle identifier is different; and set the first binding identifier as being in an activated state.

In a feasible design, when generating the first binding identifier according to the first device identifier and the first vehicle identifier, the activating module 62 is configured to determine a first binary number and a second binary number of a first character in the first vehicle identifier, where the first binary number is used to represent a position of the first character in the first vehicle identifier, the second binary number is used to represent a value of the first character, and the first character is any character in the first vehicle identifier; determine first target bytes according to the first binary number and the second binary number of each first character in the first vehicle identifier; determine a third binary number and a fourth binary number of a second character in the first device identifier, where the third binary number is used to represent a position of the second character in the first device identifier, and the fourth binary number is used to represent a value of the second character, determine second target bytes according to the third binary number and the fourth binary number of each second character in the first device identifier; and generate the first binding identifier according to the first target bytes and the second target bytes.

In a feasible design, before freezing the second binding relationship and the third binding relationship, the processing module 63 is further configured to determine whether the second binding relationship exists in the binding relationship table according to the first device identifier when the first binding identifier does not exist in the binding relationship table; and if the second binding relationship exists in the binding relationship table, determine that the first device has been bound to the second vehicle.

In a feasible design, before freezing the second binding relationship and the third binding relationship, the processing module 63 is configured to determine that whether the third binding relationship exists in the binding relationship table according to the first vehicle identifier if the first binding identifier does not exist in the binding relationship table; and if the third binding relationship exists in the binding relationship table, determine that the first vehicle has been bound to the second device.

In a feasible design, the processing module 63 is further configured to generate a key pair before the transceiving module 61 receives the request information from the first device, where the key pair includes a public key and a private key; and

the transceiving module 61 is further configured to send the public key to the first device.

In a feasible design, before generating the first binding identifier according to the first device identifier and the first vehicle identifier, the processing module 63 is further configured to decrypt encrypted data carried by the request information using the private key to obtain the first device identifier and the first vehicle identifier, where the encrypted data is obtained by the first device through encrypting the first device identifier and the first vehicle identifier using the public key.

In a feasible design, the transceiving module 61 is further configured to send the first binding identifier to the first device after the processing module 63 generates the first binding identifier according to the first device identifier and the first vehicle identifier.

FIG. 7 is another structural diagram of an information processing apparatus provided by an embodiment of the present disclosure. The apparatus may be integrated in an electronic device or implemented by an electronic device such as an on-board terminal. As shown in FIG. 7, in the present embodiment, the information processing apparatus 700 may include:

a processing module 71, configured to obtain a first device identifier for identifying a first device and a first vehicle identifier for identifying a first vehicle; and

a transceiving module 72, configured to send request information to a server, where the request information carries the first device identifier and the first vehicle identifier.

In a feasible design, before sending the request information to the server, the transceiving module 72 is further configured to receive a first binding identifier from the server, where the first binding identifier is generated by the server according to the first device identifier and the first vehicle identifier; and the processing module 71 is configured to delete a second binding identifier and store the first binding identifier when the first binding identifier and the second binding identifier are different, where the second binding identifier is a binding identifier locally stored by the first deice, and restore to a delivered state.

In a feasible design, the transceiving module 72 is further configured to receive a public key from the server before sending the request information to the server; and the processing module 71 is further configured to encrypt the first device identifier and the first vehicle identifier using the public key to obtain encrypted data, and generate the request information according to the encrypted data.

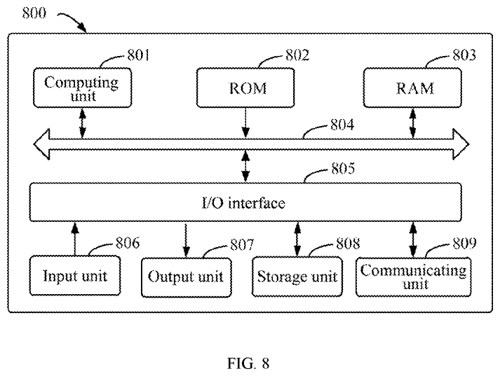

FIG. 8 is a block diagram of an electronic device for implementing an information processing method of an embodiment in the present disclosure, and the electronic device may be an on-board terminal or a server. The electronic device is intended to represent various forms of digital computers, such as a laptop computer, a desktop computer, a workstation, a personal digital assistant, a server, a blade server, a mainframe computer, and other suitable computers. The electronic device may also represent various forms of mobile apparatuses, such as a personal digital processing, a cellular phone, a smart phone, a wearable device, and other similar computing apparatuses. Components shown herein, their connections and relationships, and their functions are merely examples, which are not intended to limit implementations of the present disclosure described and/or claimed herein.

As shown in FIG. 8, the electronic device 800 includes a computing unit 801, which may perform various appropriate actions and processes according to a computer program stored in a read only memory (ROM) 802 or a computer program loaded from a storage unit 808 to a random access memory (RAM) 803. In the RAM 803, various programs and data required for an operation of the device 800 may also be stored. A computing unit 801, a ROM 802, and a RAM 803 are connected to each other through a bus 804. Input/output (I/O) interface 805 is also connected to bus 804.

A plurality of components in the device 800 are connected to the I/O interface 805, which includes: an input unit 806, such as a keyboard and a mouse; an output unit 807, such as various types of displays and speakers; a storage unit 808, such as a magnetic disk and an optical disk; and a communicating unit 809, such as a network card, a modem, and a wireless communication transceiver. The communicating unit 809 allows the device 800 to exchange information/data with other devices through a computer network such as the Internet and/or various telecommunication networks

The computing unit 801 may be various general-purpose and/or special-purpose processing components with processing and computing capabilities. Some examples of the computing unit 801 include, but are not limited to, a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, etc. The computing unit 801 performs various methods and processes described above, such as the information processing method. For example, in some embodiments, the information processing method may be implemented as a computer software program tangibly embodied in a machine-readable medium, such as the storage unit 808. In some embodiments, part or the entire computer program may be loaded and/or installed on the device 800 via the ROM 802 and/or the communicating unit 809. When the computer program is loaded into the RAM 803 and executed by the computing unit 801, one or more steps of the information processing method described above may be performed. Alternatively, in other embodiments, the computing unit 801 may be configured to perform the information processing method by any other appropriate means (for example, by means of firmware).

Various embodiments of systems and technologies described above herein may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), computer hardware, firmware, software, and/or combinations thereof. These various embodiments may include: being implemented in one or more computer programs that may be executed and/or interpreted on a programmable system including at least one programmable processor which may be a special-purpose or general-purpose programmable processor and may receive data and instructions from and transmit the data and the instructions to a storage system, at least one input apparatus, and at least one output apparatus

Program codes for implementing the method of the present disclosure may be written in any combination of one or more programming languages. These program codes may be provided to a processor or a controller of a general-purpose computer, a special-purpose computer, or other programmable data processing apparatus, so that the program codes, when executed by the processor or the controller, enables functions/operations specified in a flowchart and/or a block diagram to be implemented. The program codes may be executed completely on the machine, partially on the machine, partially on the machine as an independent software package, and partially on a remote machine or completely on a remote machine or server.

In the context of the present disclosure, a machine-readable medium may be a tangible medium that may contain or store a program for use by or in conjunction with an instruction execution system, apparatus or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any appropriate combination of the above. More specific examples of the machine readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of the above.

To provide interactions with a user, the systems and techniques described herein may be implemented on a computer having: a display apparatus (e.g., a CRT (cathode ray tube) or LCD (liquid crystal display) monitor) for displaying information to the user; and a keyboard and a pointing apparatus (e.g., a mouse or a trackball) through which the user may provide input to the computer. Other kinds of apparatuses may also be used to provide interactions with users; for example, a feedback provided to the user may be any form of sensory feedback (for example, a visual feedback, an auditory feedback, or a tactile feedback); and input from the user may be received in any form (including acoustic input, voice input, or tactile input).

The systems and technologies described herein may be implemented in a computing system including background components (e.g., as a data server), a computing system including middleware components (e.g., an application server), or a computing system including front-end components (e.g., a user computer with a graphical user interface or a web browser through which a user may interact with implementations of the systems and techniques described herein), or a computing system including any combination of such background components, middleware components, or front-end components. Components of the systems may be connected to each other through a digital data communication in any form or medium (e.g., communication network). An example of a communication network includes: a local area network (LAN), a wide area network (WAN), and the Internet.

A computer system may include a client and a server. The client and the server are generally remote from each other and usually interact through a communication network. A relationship between the client and the server is generated by a computer program running on a corresponding computer and having a client-server relationship with each other. The server may be a cloud server, also known as a cloud computing server or a cloud host, which is a host product in a cloud computing service system to solve defects of difficult management and weak traffic scalability in a conventional physical host and a VPS service (Virtual Private Server or VPS for short). The server may also be a server of a distributed system or a server combined with a blockchain.

According to the technical solutions in the embodiments of the present disclosure, a vehicle and an on-board terminal are bound automatically, thereby improving binding efficiency and reducing an error rate, and at the same time, achieving that one vehicle can only be bound to one on-board terminal at any time while one on-board terminal can only be bound to one vehicle.

It should be understood that steps may be reordered, added or deleted using various forms of flows shown above. For example, steps described in the present disclosure may be executed in parallel, sequentially, or in a different order, as long as a desired result of the technical solutions disclosed in the present disclosure can be achieved, which is not limited herein.

The above specific implementations do not limit protection scope of the present disclosure. It should be understood by persons skilled in the art that various modifications, combinations, subcombinations, and substitutions may be made according to design requirements and other factors. Any modification, equivalent substitution, and improvement made within spirit and principle of the present disclosure shall be included in the protection scope of the present disclosure.

What is claimed is:

1. An information processing method, comprising:
receiving request information from a first device, wherein the request information carries a first device identifier for identifying the first device and a first vehicle identifier for identifying a first vehicle;
activating a first binding relationship between the first device identifier and the first vehicle identifier; and
freezing a second binding relationship and a third binding relationship, wherein the second binding relationship is a binding relationship between the first device identifier and a second vehicle identifier for identifying a second vehicle, and the third binding relationship is a binding relationship between a second device identifier for identifying a second device and the first vehicle identifier.

2. The method according to claim 1, wherein the activating a first binding relationship between the first device identifier and the first vehicle identifier, comprises:
generating a first binding identifier according to the first device identifier and the first vehicle identifier;
when the first binding identifier does not exist in a binding relationship table, adding the first binding relationship, the first binding identifier, and a corresponding relationship between the first binding relationship and the first binding identifier to the binding relationship table, wherein the binding relationship table is used to store a corresponding relationship among a device identifier, a vehicle identifier, and a binding identifier, different corresponding relationships contain different binding identifiers, and at least one of the device identifier and the vehicle identifier is different; and
setting the first binding identifier as being in an activated state.

3. The method according to claim 2, wherein the generating a first binding identifier according to the first device identifier and the first vehicle identifier, comprises:
determining a first binary number and a second binary number of a first character in the first vehicle identifier, wherein the first binary number is used to represent a position of the first character in the first vehicle identifier, the second binary number is used to represent a value of the first character, and the first character is any character in the first vehicle identifier;
determining first target bytes according to the first binary number and the second binary number of each first character in the first vehicle identifier;
determining a third binary number and a fourth binary number of a second character in the first device identifier, wherein the third binary number is used to represent a position of the second character in the first device identifier, and the fourth binary number is used to represent a value of the second character;
determining second target bytes according to the third binary number and the fourth binary number of each second character in the first device identifier; and
generating the first binding identifier according to the first target bytes and the second target bytes.

4. The method according to claim 2, wherein before the freezing a second binding relationship and a third binding relationship, the method further comprises:
when the first binding identifier does not exist in the binding relationship table, determining whether the second binding relationship exists in the binding relationship table according to the first device identifier; and
in a condition that the second binding relationship exists in the binding relationship table, determining that the first device has been bound to the second vehicle.

5. The method according to claim 2, wherein before the freezing a second binding relationship and a third binding relationship, the method further comprises:
in a condition that the first binding identifier does not exist in the binding relationship table, determining whether the third binding relationship exists in the binding relationship table according to the first vehicle identifier; and
in a condition that the third binding relationship exists in the binding relationship table, determining that the first vehicle has been bound to the second device.

6. The method according to claim 2, wherein before the receiving request information from a first device, the method further comprises:
generating a key pair, wherein the key pair comprises a public key and a private key; and
sending the public key to the first device.

7. The method according to claim 6, wherein before the generating a first binding identifier according to the first device identifier and the first vehicle identifier, the method further comprises:
decrypting encrypted data carried by the request information using the private key to obtain the first device identifier and the first vehicle identifier, wherein the encrypted data is obtained by the first device through encrypting the first device identifier and the first vehicle identifier using the public key.

8. The method according to claim 2, wherein after the generating a first binding identifier according to the first device identifier and the first vehicle identifier, the method further comprises:
sending the first binding identifier to the first device.

9. An information processing apparatus, comprising:
at least one processor;
a transceiver; and
a memory communicatively connected to the at least one processor; wherein,
the memory stores an instruction executable by the at least one processor, and the instruction is executed by the at least one processor to enable the at least one processor to:
control the transceiver to receive request information from a first device, wherein the request information carries a first device identifier for identifying the first device and a first vehicle identifier for identifying a first vehicle;
activate a first binding relationship between the first device identifier and the first vehicle identifier; and
freeze a second binding relationship and a third binding relationship, wherein the second binding relationship is a binding relationship between the first device identifier and a second vehicle identifier for identifying a second vehicle, and the third binding relationship is a binding relationship between a second device identifier for identifying a second device and the first vehicle identifier.

10. The apparatus according to claim 9, wherein the at least one processor is further enabled to:
generate a first binding identifier according to the first device identifier and the first vehicle identifier; when the first binding identifier does not exist in a binding relationship table, add the first binding relationship, the first binding identifier, and a corresponding relationship between the first binding relationship and the first binding identifier to the binding relationship table, wherein the binding relationship table is used to store a corresponding relationship among a device identifier, a vehicle identifier, and a binding identifier, different corresponding relationships contain different binding identifiers, and at least one of the device identifier and the vehicle identifier is different; and set the first binding identifier as being in an activated state.

11. The apparatus according to claim 10, wherein the at least one processor is further enabled to: when generating the first binding identifier according to the first device identifier and the first vehicle identifier, determine a first binary number and a second binary number of a first character in the first vehicle identifier, wherein the first binary number is used to represent a position of the first character in the first vehicle identifier, the second binary number is used to represent a value of the first character, and the first character is any character in the first vehicle identifier; determine first target bytes according to the first binary number and the second binary number of each first character in the first vehicle identifier; determine a third binary number and a fourth binary number of a second character in the first device identifier, wherein the third binary number is used to represent a position of the second character in the first device identifier, and the fourth binary number is used to represent a value of the second character; determine second target bytes according to the third binary number and the fourth binary number of each second character in the first device identifier; and generate the first binding identifier according to the first target bytes and the second target bytes.

12. The apparatus according to claim 10, wherein the at least one processor is further enabled to:
before freezing the second binding relationship and the third binding relationship, determine whether the second binding relationship exists in the binding relationship table according to the first device identifier when the first binding identifier does not exist in the binding relationship table; and in a condition that the second binding relationship exists in the binding relationship table, determine that the first device has been bound to the second vehicle.

13. The apparatus according to claim 12, wherein the at least one processor is further enabled to:
before freezing the second binding relationship and the third binding relationship, determine whether the third binding relationship exists in the binding relationship table according to the first vehicle identifier in a condition that the first binding identifier does not exist in the binding relationship table; and in a condition that the third binding relationship exists in the binding relationship table, determine that the first vehicle has been bound to the second device.

14. The apparatus according to claim 10, wherein the at least one processor is further enabled to:
generate a key pair before the transceiver receives the request information from the first device, wherein the key pair comprises a public key and a private key; and
control the transceiver to send the public key to the first device.

15. The apparatus according to claim 14, wherein the at least one processor is further enabled to: before generating the first binding identifier according to the first device identifier and the first vehicle identifier, decrypt encrypted data carried by the request information using the private key to obtain the first device identifier and the first vehicle identifier, wherein the encrypted data is obtained by the first device through encrypting the first device identifier and the first vehicle identifier using the public key.

16. The apparatus according to claim 10, wherein the at least one processor is further enabled to:
control the transceiver to send the first binding identifier to the first device after the at least one processor generates the first binding identifier according to the first device identifier and the first vehicle identifier.

17. An information processing apparatus, comprising:
at least one processor;
a transceiver; and
a memory communicatively connected to the at least one processor; wherein,
the memory stores an instruction executable by the at least one processor, and the instruction is executed by the at least one processor to enable the at least one processor to:
obtain a first device identifier for identifying a first device and a first vehicle identifier for identifying a first vehicle; and
control the transceiver to send request information to a server, wherein the request information carries the first device identifier and the first vehicle identifier.

18. The apparatus according to claim 17, wherein the at least one processor is further enabled to:
before sending the request information to the server, control the transceiver to receive a first binding identifier from the server, wherein the first binding identifier is generated by the server according to the first device identifier and the first vehicle identifier; and
delete a second binding identifier and store the first binding identifier when the first binding identifier and the second binding identifier are different, wherein the second binding identifier is a binding identifier locally stored by the first deice, and restore to a delivered state.

19. The apparatus according to claim 17, wherein the at least one processor is further enabled to:
control the transceiver to receive a public key from the server before sending the request information to the server; and
encrypt the first device identifier and the first vehicle identifier using the public key to obtain encrypted data, and generate the request information according to the encrypted data.

20. A non-transitory computer readable storage medium storing a computer instruction, wherein the computer instruction is used to enable an electronic device to execute the method according to claim 1.
